(19) United States
(12) Patent Application Publication
(10) Pub. No.: US 2012/0148149 A1
(43) Pub. Date: Jun. 14, 2012

(54) VIDEO KEY FRAME EXTRACTION USING SPARSE REPRESENTATION

(76) Inventors: Mrityunjay Kumar, Rochester, NY (US); Jie Yu, Schenectady, NY (US); Alexander C. Loui, Penfield, NY (US)

(21) Appl. No.: 12/964,778

(22) Filed: Dec. 10, 2010

(51) Int. Cl. G06K 9/48; G06K 9/00

(52) U.S. Cl. 382/162; 382/197

(57) ABSTRACT

A method for identifying a set of key frames from a video sequence including a time sequence of video frames, comprising: extracting a feature vector for each video frame in a set of video frames selected from the video sequence; defining a set of basis functions that can be used to represent the extracted feature vectors, wherein each basis function is associated with a different video frame in the set of video frames; representing the feature vectors for each video frame in the set of video frames as a sparse combination of the basis functions associated with the other video frames; and analyzing the sparse combinations of the basis functions for the set of video frames to select the set of key frames.

### CROSS-REFERENCE TO RELATED APPLICATIONS

Reference is made to commonly assigned, co-pending U.S. patent application Ser. No. 12/908,022 (docket 96459), entitled: “Video summarization using sparse basis function combination”, by Kumar et al., and to commonly assigned, co-pending U.S. patent application Ser. No. ______/______ (docket 96458), entitled: “Video key-frame extraction using bi-level sparsity”, by Kumar et al., both of which are incorporated herein by reference.

### FIELD OF THE INVENTION

This invention relates generally to the field of video understanding, and more particularly to a method to extract key frames from digital video using a sparse signal representation.

### BACKGROUND OF THE INVENTION

Video key-frame extraction algorithms select a subset of the most representative frames from an original video. Key-frame extraction finds applications in several broad areas of video processing research such as video summarization, creating “chapter titles” in DVDs, and producing “video action prints.”

Video key-frame extraction is an active research area, and many approaches for extracting key frames from the original video have been proposed. Conventional key-frame extraction approaches can be loosely divided into two groups: (i) shot-based, and (ii) segment-based. In shot-based video key-frame extraction, the shots of the original video are first detected, and then one or more key frames are extracted for each shot. For example, Uchihashi et al., in the article “Summarizing video using a shot importance measure and a frame-packing algorithm” (IEEE International Conference on Acoustics, Speech and Signal Processing, pp. 3041-3044, 1999) teach segmenting a video into its component shots. Unimportant shots are then discarded using a measure of shot importance. The key-frames are generated for each of the remaining important shots.

Another method taught by Zhang et al. in the article “An integrated system for content-based video retrieval and browsing” (Pattern Recognition, pp. 643-658, 1997) segments a video into shots and determines key frames for each shot based on feature and content information.

Arman et al., in the article “Content-based browsing of video sequences” (Proc. 2nd ACM International Conference on Multimedia, pp. 97-103, 1994) teach using video shots as the basic building blocks. After shot detection, the tenth frame of each shot is selected as the key frame.

Another method taught by Wang et al., in the article “Video summarization by redundancy removing and content ranking” (Proc. 15th International Conference on Multimedia, pp. 577-580, 2007), detects shot boundaries by color histogram and optical-flow motion features, and extracts key frames in each shot by a leader-follower clustering algorithm. A video summary is then generated by key frame clustering and repetitive segment detection.

In segment-based video key-frame extraction approaches, a video is segmented into higher-level video components, where each segment or component could be a scene, an event, a set of one or more shots, or even the entire video sequence. Representative frame(s) from each segment are then selected as the key frames.

In U.S. Pat. No. 7,110,458, entitled “Method for summarizing a video using motion descriptors”, Divakaran et al. teach a method for forming a video summary that measures an intensity of motion activity in a compressed video and uses the intensity information to partition the video into segments. Key frames are then selected from each segment. The selected key frames are concatenated in temporal order to form a summary of the video.

Uchihashi et al., in the article “Video manga: generating semantically meaningful video summaries” (Proc. 7th ACM International Conference on Multimedia, pp. 383-392, 1999) use a tree-structured representation to cluster all the frames of the video into a predefined number of clusters. This information is then exploited to segment the video. The relevant key frames for each segment are selected based on the relative importance of video segments.

Rasheed et al., in the article “Detection and representation of scenes in videos” (IEEE Multimedia, pp. 1097-1105, 2005) construct a weighted undirected graph called a “shot similarity graph” (SSG) for clustering shots into scenes. The content of each scene is described by selecting one representative frame from the corresponding scene as a scene key-frame.

Girgensohn et al., in the article “Time-constrained keyframe selection technique” (IEEE International Conference on Multimedia Computing Systems, pp. 756-761, 1999) use a hierarchical clustering algorithm to cluster similar frames. Key frames are extracted by selecting one frame from each cluster.

Another method taught by Doulamis et al., in the article “A fuzzy video content representation for video summarization and content-based retrieval” (Signal Processing, pp. 1049-1067, 2000) extracts key frames by minimizing a cross correlation criterion among the video frames by means of a genetic algorithm. The correlation is computed using several features extracted using color/motion segmentation on a fuzzy feature vector formulation basis.

All of the above methods rely on the accuracies of the feature selection and clustering algorithms used for shot detection and video segmentation. Furthermore, these approaches are vulnerable to noise, and are not very data adaptive. Thus, there exists a need for video key-frame extraction framework that is data adaptive, robust to noise, and less sensitive to feature selection.

### SUMMARY OF THE INVENTION

The present invention represents a method for identifying a set of key frames from a video sequence including a time sequence of video frames, the method executed at least in part by a data processor, comprising:

a) extracting a feature vector for each video frame in a set of video frames selected from the video sequence;

b) defining a set of basis functions that can be used to represent the extracted feature vectors, wherein each basis function is associated with a different video frame in the set of video frames;

c) representing the feature vectors for each video frame in the set of video frames as a sparse combination of the basis functions associated with the other video frames; and

d) analyzing the sparse combinations of the basis functions for the set of video frames to select the set of key frames.

The present invention has the advantage that the key frames are identified using sparse-representation-based-framework, which is data-adaptive, and robust to measurement noise.

It has the additional advantage that it can incorporate low-level video image quality information such as blur, noise and sharpness, as well as high-level semantics information such as face detection, motion detections and semantic classifiers.

### BRIEF DESCRIPTION OF THE DRAWINGS

FIG. 1 is a high-level diagram showing the components of a system for summarizing digital video according to an embodiment of the present invention;

FIG. 2 is a flow diagram illustrating a method for identifying a set of key frames from a digital video according to an embodiment of the present invention;

FIG. 3 is a block diagram showing a detailed view of the get sparse combination set step of FIG. 2;

FIG. 4 is a block diagram showing a detailed view of the select key frames set step of FIG. 2;

FIG. 5 is a block diagram showing a detailed view of the select key frames set step of FIG. 2 according to an alternate embodiment of the present invention; and

FIG. 6 shows an example of a ranking function plotting ranking score as a function of frame number.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting.

The phrase, “digital content record”, as used herein, refers to any digital content record, such as a digital still image, a digital audio file, or a digital video file.

It should be noted that, unless otherwise explicitly noted or required by context, the word “or” is used in this disclosure in a non-exclusive sense.

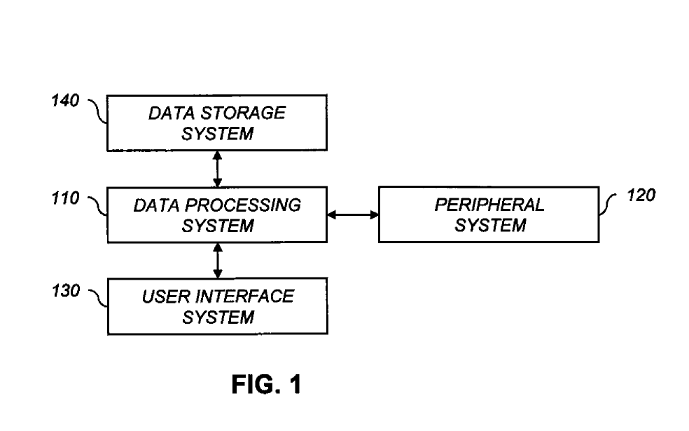

FIG. 1 is a high-level diagram showing the components of a system for identifying a set of key frames from a video sequence according to an embodiment of the present invention. The system includes a data processing system 110, a peripheral system 120, a user interface system 130, and a data storage system 140. The peripheral system 120, the user interface system 130 and the data storage system 140 are communicatively connected to the data processing system 110.

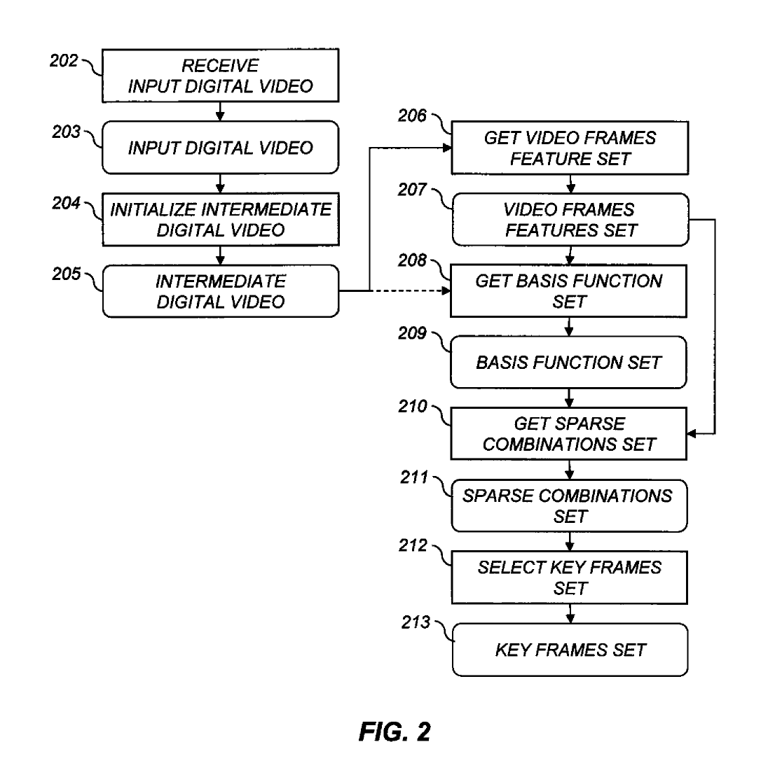

The data processing system 110 includes one or more data processing devices that implement the processes of the various embodiments of the present invention, including the example processes of FIGS. 2-5 described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The data storage system 140 includes one or more processor-accessible memories configured to store information, including the information needed to execute the processes of the various embodiments of the present invention, including the example processes of FIGS. 2-5 described herein. The data storage system 140 may be a distributed processor-accessible memory system including multiple processor-accessible memories communicatively connected to the data processing system 110 via a plurality of computers or devices. On the other hand, the data storage system 140 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated.

The phrase “communicatively connected” is intended to include a connection between devices or programs within a single data processor, a connection between devices or programs located in different data processors, and a connection between devices not located in data processors at all. In this regard, although the data storage system 140 is shown separately from the data processing system 110, one skilled in the art will appreciate that the data storage system 140 may be stored completely or partially within the data processing system 110. Further in this regard, although the peripheral system 120 and the user interface system 130 are shown separately from the data processing system 110, one skilled in the art will appreciate that one or both of such systems may be stored completely or partially within the data processing system 110.

The peripheral system 120 may include one or more devices configured to provide digital content records to the data processing system 110. For example, the peripheral system 120 may include digital still cameras, digital video cameras, cellular phones, or other data processors. The data processing system 110, upon receipt of digital content records from a device in the peripheral system 120, may store such digital content records in the data storage system 140.

The user interface system 130 may include a mouse, a keyboard, another computer, or any device or combination of devices from which data is input to the data processing system 110. In this regard, although the peripheral system 120 is shown separately from the user interface system 130, the peripheral system 120 may be included as part of the user interface system 130.

The user interface system 130 also may include a display device, a processor-accessible memory, or any device or combination of devices to which data is output by the data processing system 110. In this regard, if the user interface system 130 includes a processor-accessible memory, such memory may be part of the data storage system 140 even though the user interface system 130 and the data storage system 140 are shown separately in FIG. 1.

FIG. 2 is a flow diagram illustrating a method for identifying a set of key frames from a video sequence according to an embodiment of the present invention. An input digital video 203 representing a video sequence captured of a scene is received in a receive input digital video step 202. The video sequence includes a time sequence of video frames. The input digital video 203 can be captured using any video capture device known in the art such as a video camera or a digital still camera with a video capture mode, and can be received in any digital video format known in the art.

An initialize intermediate digital video step 204 is used to initialize an intermediate digital video 205. The intermediate digital video 205 is a modified video estimated from the input digital video 203.

A get video frames feature set step 206 uses the intermediate digital video 205 to produce a video frames features set 207. The video frames features set 207 contains the feature vector for each video frame of the intermediate digital video 205.

A get basis function set step 208 determines a set of basis functions collected in a basis function set 209 responsive to the video frames features set 207. The get basis function set step 208 is optionally responsive to the intermediate digital video 205. (Note that optional features are represented with dashed lines.) The basis function set 209 is used to represent the feature vectors of the video frames features set 207 and each basis function in the basis function set 209 is associated with a different video frame in the intermediate digital video 205.

A get sparse combinations set step 210 uses the basis function set 209 and the video frames features set 207 to represent the feature vectors for each video frame stored in the video frames features set 207 as a sparse combination of the basis functions for the other video frames collected in the basis function set 209. The sparse combinations produced with the get sparse combination set step 210 are stored in a spare combination set 211. Finally, a select key frames set step 212 analyzes the sparse combinations set 211 to produce a key frames set 213 that contains the key frames for the input digital video 203 selected at the select key frames set step 212.

The individual steps outlined in FIG. 2 will now be described in greater detail. The initialize intermediate digital video step 204 is a preprocessing step that preprocesses the input digital video 203 to produce the intermediate digital video 205. The intermediate digital video 205 is more suitable for the subsequent steps carried out to produce the key frames set 213. The intermediate digital video 205 can be generated using any appropriate method known to those skilled in the art. In one embodiment, the intermediate digital video 205 contains all of the frames of the input digital video 203. In a preferred embodiment of the present invention, the intermediate digital video 205 is a subset of the video frames of the input digital video 203 produced by down-sampling each frame of the input digital video 203 by a factor of 2× in both the horizontal and vertical directions and only retaining every 3rd frame of the input digital video 203. It will be obvious to one skilled in the art that different spatial and temporal down-sampling rates can be applied in accordance with the present invention. Additionally, other types of processing steps such as color adjustment, sharpening and noise removal can also be included in the initialize intermediate digital video step 204.

The get video frames feature set step 206 uses the intermediate digital video 205 to produce the video frames features set 207. The get video frames feature set step 206 extracts a feature vector for each frame of the intermediate digital video 205. All the extracted feature vectors are then stored in the video frames features set 207. The video frames features set 207 can be determined using any appropriate method known to those skilled in the art. In a preferred embodiment of the present invention, the get video frames feature set step 206 extracts a visual features vector for each frame of the intermediate digital video 205. Each visual features vector contains parameters related to video frame attributes such as color, texture, and edge orientation present in a frame. In a preferred embodiment, visual feature vectors are determined using the method described by Xiao et al. in “SUN Database: Large-scale scene recognition from abbey to zoo” (IEEE Conference on Computer Vision and Pattern Recognition, pp. 3485-3492, 2010). These feature vectors include parameters related to the following visual features: a color histogram, a histogram of oriented edges, GIST features, and dense SIFT features. The parameters determined for each of the visual features are concatenated together to form a single visual feature vector for each frame. In another embodiment, a feature vector for each frame of the intermediate digital video 205 is determined by applying a set of filters to the corresponding frame. Examples of sets of filters that can be used for this purpose include wavelet filters, Gabor filters, DCT filters, and Fourier filters.

The get basis function set step 208 uses the video frames features set 207 to produce a set of basis functions to represent the feature vectors of the video frames features set 207. The set of basis functions produced by the get basis function set step 208 are collected in the basis function set 209. Each basis function of the basis function set 209 is associated with a different feature vector of the video frames features set 207, and each feature vector of the video frames features set 207 is associated with a different frame of the intermediate digital video 205. The basis function set 209 can be determined using any appropriate method known to those skilled in the art. In a preferred embodiment of the present invention, the feature vector from the video frames features set 207 corresponding to a particular frame of the intermediate digital video 205 is selected as the basis function for that frame. In some embodiments, the basis functions are defined responsive to the extracted feature vectors rather than being equal to the feature vectors.

In another embodiment, the get basis function set step 208 extracts a visual feature vector for each frame of the intermediate digital video 205, and each visual feature vector is then used as the basis function for the corresponding frame. Each visual features vector contains parameters related to video frame attributes such as color, texture, edge orientation present in a frame. Example of particular visual features that can be used in accordance with the present invention include: color histograms, histograms of oriented edges, GIST features, and dense SIFT features as described in the aforementioned article by Xiao et al. Basis functions computed this way are stored in the basis function set 209.

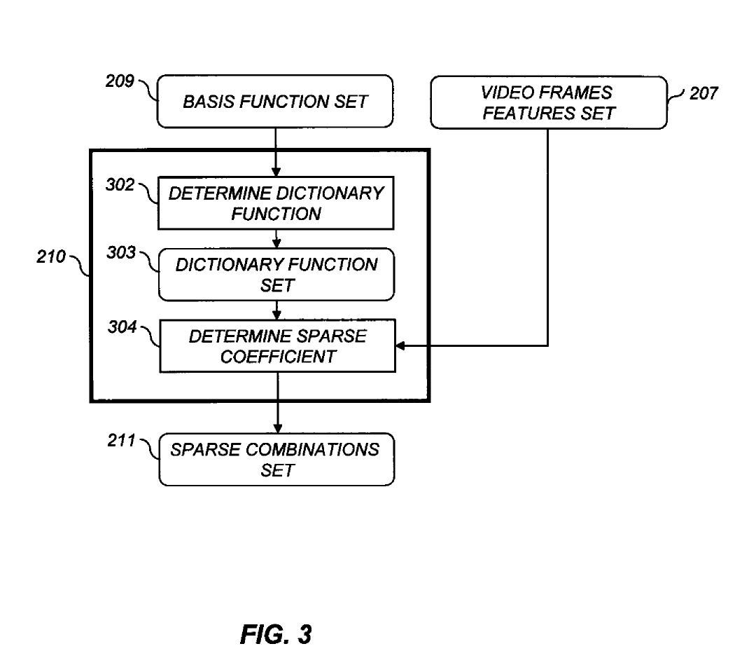

FIG. 3 is a more detailed view of the get sparse combinations set step 210 according to a preferred embodiment of the present invention. A determine dictionary function step 302 produces a dictionary function set 303 responsive to the basis function set 209. The dictionary function set 303 will be used to represent each feature vector of the video frames features set 207 as a sparse combination of the basis functions for the other video frames stored in the basis function set 209. The determine dictionary function step 302 can use any appropriate method known to those skilled in the art to determine the dictionary function set 303. In a preferred embodiment, the determine dictionary function step 302 determines a matrix function for each frame of the intermediate digital video 205 (FIG. 2), and the matrix functions for all the frames of the intermediate digital video 205 are stored in the dictionary function set 303. This is explained in details next.

Let bᵢ be the value of the i^{th} basis function of the basis function set 209, corresponding to the i^{th} frame of the intermediate digital video 205, where 1 n (n being the number of frames). Let Aᵢ be the matrix function determined by the determine dictionary function step 302 for the i^{th} frame of the intermediate digital video 205. In a preferred embodiment of the present invention, Aᵢ is formed by:

Aᵢ=[b₁, . . . , bᵢ₋₁, bᵢ₊₁, . . . , bₙ] (1)

where each column of the matrix function Aᵢ corresponds to a different basis function. Note that the matrix function Aᵢ excludes the basis function for the i^{th} frame (bᵢ) such that the matrix function Aᵢ will have n-1 columns. The dictionary function set 303 contains matrix functions Aᵢ for all the frames of the intermediate digital video 205 (i.e., 1≦i≦n).

A determine sparse coefficient step 304 uses the dictionary function set 303 and the video frames features set 207 to represent each feature vector of the video frames features set 207 as a sparse combination of the columns of the corresponding matrix function from the dictionary function set 303. The sparse combinations for all the feature vectors of the video frames features set 207 are stored in the sparse combinations set 211. The determine sparse coefficient step 304 can use any appropriate method known to those skilled in the art to determine the sparse combinations set 211. In a preferred embodiment of the present invention, the sparse combination for a particular feature vector of the video frames features set 207 is defined as a set of weighting coefficients for the basis functions of the basis function set 209, wherein the set of the weighting coefficients is determined such that only a few coefficients are non-zero. This is explained next.

Let fᵢ be the value of the i^{th} feature vector of the video frames features set 207 extracted from the i^{th} frame of the intermediate digital video 205, where 1≦i≦n. The determine sparse coefficient step 304 determines the set of weighting coefficients for fᵢ by representing it as a sparse weighted linear combinations of the columns of the i^{th} matrix function Aᵢ. In an equation form, this sparse combination can be expressed by:

fᵢ=Aᵢαᵢ (2)

where αᵢ is the set of weighting coefficients assigned to the basis functions of the basis function set 209 arranged as columns in Aᵢ and where only a minority of the elements of αᵢ are non-zero.

Due to the sparse nature of αᵢ, the linear combination in Eq. (2) is called a sparse combination. Mathematical algorithms for determining sparse combinations are well-known in the art. An in-depth analysis of sparse combinations, their mathematical structure and their relevancy, can be found in the article entitled “From sparse solutions of systems of equations to sparse modeling of signals and images,” (SIAM Review, pp. 34-81, 2009) by Bruckstein et al.

The determine sparse coefficient step 304 solves Eq. (2) for each feature vector of the video frames features set 207; the sparse combinations set 211 is then determined by collecting all the sparse vectors of weighting coefficients (i.e., α₁, . . . , αₙ). Note that for each αᵢ a zero value is inserted at the i^{th} location, corresponding to the position where the bᵢ was excluded from the matrix function Aᵢ, so that the dimension of α*ᵢ is the same as the corresponding feature fᵢ.) The set of weighting coefficients αᵢ for the sparse combination can be determined using any appropriate method known to those skilled in the art. In a preferred embodiment of the present invention, αᵢ is estimated using the well known optimization approach as explained in the article entitled “An interior-point method for large-scale l₁-regularized least squares” (IEEE Journal of Selected Topics in Signal Processing, pp. 606-617, 2007) by Kim et al. In this approach, αᵢ is estimated by minimizing Eq. (3) as given below:

α*ᵢ=arg min ∥fᵢ−Aᵢαᵢ∥₂²+λ∥αᵢ∥₁ (3)

where α*ᵢ is the estimated value of αᵢ, ∥•∥₂ and ∥•∥₁ denote l₂- and l₁-norm, respectively, and λ (>0) is the regularization parameter that controls the sparsity of αᵢ. Preferably, λ is chosen such that each αᵢ contains non-zero weighting coefficients for less than 10% of the basis function, Aᵢ.

The non-zero coefficients of αᵢ correspond to only those basis functions of Aᵢ that are most important to reconstruct fᵢ. Therefore, these non-zero coefficients indicate the dependency of fᵢ and the columns of Aᵢ, which in turn indicate a mutual dependency between the i^{th} video frame and the video frames corresponding to the basis functions having the non-zero weighting coefficients.

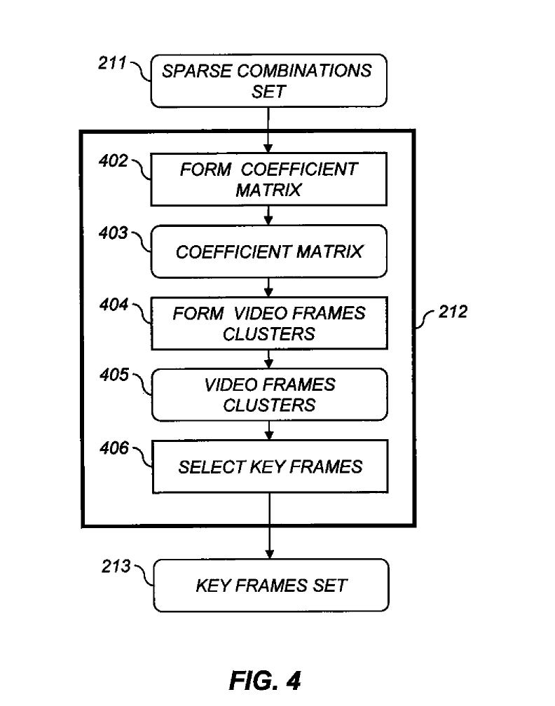

FIG. 4 is a more detailed view of the select key frames set step 212 of FIG. 2 according to a preferred embodiment of the present invention. A form coefficient matrix step 402 produces a coefficient matrix 403 responsive to the sparse combinations set 211. The coefficient matrix 403 quantifies the mutual dependency among the frames of the intermediate digital video 205 (FIG. 2). The form coefficient matrix step 402 can use any appropriate method known to those skilled in the art to determine the coefficient matrix 403. In a preferred embodiment of the present invention, each row of the coefficient matrix is comprised of the weighting coefficients for a different feature vector stored in the sparse combinations set 211. In an equation form, the coefficient matrix 403 can be expressed as:

$$C = [ \begin{matrix}{α}_{1} \\ {α}_{2} \\ ⋮ \\ {α}_{n}\end{matrix} ] \qquad ( 4 )$$

where C is the coefficient matrix 403.

A form video frames clusters step 404 uses the coefficient matrix 403 to produce a set of video frames clusters 405. The video frames clusters 405 contain at least one cluster of similar frames of the intermediate digital video 205 produced by the form video frames clusters step 404 by analyzing the coefficient matrix 403. The form video frames clusters step 404 can use any appropriate method known to those skilled in the art to determine the video frames clusters 405. In a preferred embodiment of the present invention, spectral clustering, a well-known clustering algorithm, is applied to the coefficient matrix 403 (C) to generate one or more clusters of similar frames of the intermediate digital video 205. More details about spectral clustering can be found in the article “A tutorial on spectral clustering” (Journal of Statistics and Computing, Vol. 17, pp. 395-416, 2007) by von Luxburg.

A select key frames step 406 selects at least one representative frame from each of the video frames clusters 405 to produce the key frames set 213. The key frames set 213 contains all the representative frames selected with the select key frames step 406. The select key frames step 406 can use any appropriate method known to those skilled in the art to select key frames from the video frames clusters 405. In a preferred embodiment of the present invention, the frame of the intermediate digital video 205 that is closest to the centroid of each of the video frames clusters 405 is selected as a key frame.

In another embodiment, an image quality metric is determined for each frame in a particular video frames cluster 405. The frame having the highest image quality metric value is then selected as a key frame. Examples of image quality attributes that can be evaluated to determine the image quality metric include detecting the presence of one or more faces in the video frame, estimating a noise level for the video frame, estimating a blur level for the video frame, and estimating a sharpness level for the video frame. Methods for determining these and other quality attributes are well-known in the art. For example, a method for detecting faces in a digital image is described by Romdhani et al. in the article “Computationally Efficient Face Detection” (Proc. 8^{th} International Conference on Computer Vision, pp. 695-700, 2001); a method for estimating noise in a digital image is described by Liu et al. in the article “Noise estimation from a single image” (IEEE Conference on Computer Vision and Pattern Recognition, pp. 901-908, 2006); and a method for estimating a sharpness level for a digital image is described by Ferzli et al. in the article “A no-reference objective image sharpness metric based on just-noticeable blur and probability summation” (IEEE International Conference on Image Processing, Vol. III, pp. 445-448, 2007). Other examples of image quality attributes that would be related to image quality include detecting rapid motion changes and classifying the video frames using semantic classification algorithms. When a plurality of quality attributes are determined for a given frame, they can be combined using any method known in the art to determine the overall visual quality score for the frame. For example, the image quality attributes can be combined using a weighted summation.

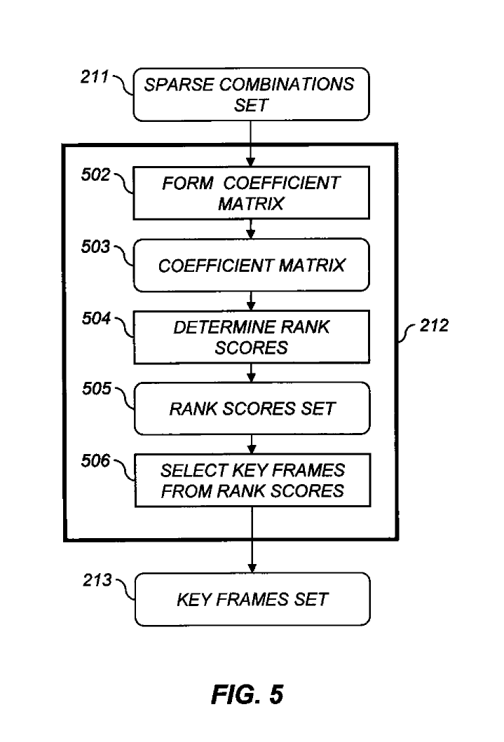

FIG. 5 shows an alternate embodiment of the select key frames set step 212 from FIG. 2. A form coefficient matrix step 502 produces a coefficient matrix 503 responsive to the sparse combinations set 211. The form coefficient matrix step 502 can use any appropriate method known to those skilled in the art to determine the coefficient matrix 503. In a preferred embodiment of the present invention, the coefficient matrix 503 is the same as the coefficient matrix C given by Eq. (4).

A determine rank scores step 504 uses the coefficient matrix 503 to produce a rank scores set 505. The rank scores set 505 contains ranking scores for each frame of the intermediate digital video 205 (FIG. 2). Ranking scores stored in the rank scores set 505 indicate the relative importance of the frames of the intermediate digital video 205. The determine rank scores step 504 can use any appropriate method known to those skilled in the art to determine the rank scores set 505. In a preferred embodiment of the present invention, the determine rank scores step 504 uses a link analysis algorithm to analyze the coefficient matrix 503 to determine ranking scores for each frames of the intermediate digital video 205. Link analysis techniques have been extensively used for discovering the most informative nodes in a graph, and several link analysis algorithms have been described in the literature. In a preferred embodiment, the PageRank link analysis algorithm, discussed by Brin et al. in the article “The anatomy of a large-scale hypertextual web search engine” (Proc. International Conference on World Wide Web, pp. 107-117, 1998), is used to determine the ranking scores.

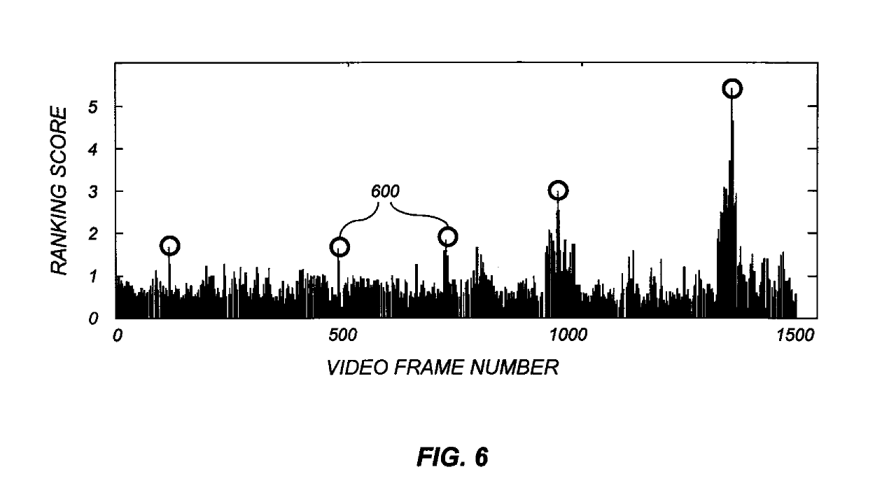

A select key frames from rank scores step 506 produces the key frames set 213 responsive to the rank scores set 505. The select key frames from rank scores step 506 can use any appropriate method known to those skilled in the art to produce the key frames set 213. In one embodiment of the present invention, video frames with the highest ranking scores are selected for inclusion in the key frames set 213. In a preferred embodiment of the present invention, a ranking function expressing the ranking score as a function of a frame number of the intermediate digital video 205 is formed and the key frames set 213 is produced by selecting one or more frames of the intermediate digital video 205 corresponding to local extrema (e.g., local maxima) of the ranking function to be included in the key frames set 213. FIG. 6 shows an example graph of a ranking function. In this graph, the horizontal axis is the frame number of the intermediate digital video 205 and the vertical axis is the ranking score from the rank score set 505. The local maxima 600 corresponding to the frames selected for inclusion in the key frames set 213 are circled in the ranking function graph.

The key frames of the input digital video 203 stored in the key frames set 213 can further be used for various purposes. For example, the key frames can be used to index the video sequence, to create video thumbnails, to create a video summary, to extract still image files, to make a photo collage or to make prints.

It is to be understood that the exemplary embodiments disclosed herein are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

110 Data processing system
120 Peripheral system
130 user interface system
140 data storage system
202 receive input digital video step
203 input digital video
204 initialize intermediate digital video step
205 intermediate digital video
206 get video frames feature set step
207 video frames features set
208 get basis function set step
209 basis function set
210 get sparse combinations set step
211 sparse combinations set
212 select key frames set step
213 key frames set
302 determine dictionary function step
303 dictionary function set
304 determine sparse coefficient step
402 form coefficient matrix step
403 coefficient matrix
404 form video frames clusters step
405 video frames clusters
406 select frames from video frames clusters step
502 form coefficient matrix step
503 coefficient matrix
504 determine rank scores step
505 rank scores set
506 select key frames from rank scores step
600 local maxima

1. A method for identifying a set of key frames from a video sequence including a time sequence of video frames, the method executed at least in part by a data processor, comprising:
a) extracting a feature vector for each video frame in a set of video frames selected from the video sequence;
b) defining a set of basis functions that can be used to represent the extracted feature vectors, wherein each basis function is associated with a different video frame in the set of video frames;
c) representing the feature vectors for each video frame in the set of video frames as a sparse combination of the basis functions associated with the other video frames; and
d) analyzing the sparse combinations of the basis functions for the set of video frames to select the set of key frames.

2. The method of claim 1 wherein the sparse combination for a particular video frame is defined by a set of weighting coefficients for the basis functions, and wherein non-zero weighting coefficients in the sparse combination indicate a mutual dependency between the particular video frame and the video frames corresponding to the basis functions having the non-zero weighting coefficients.

3. The method of claim 1 wherein the sparse combination has non-zero weighting coefficients for no more than 10% of the basis functions.

4. The method of claim 1 wherein the set of video frames is all of the video frames in the video sequence.

5. The method of claim 1 wherein the set of video frames is a subset of the video frames in the video sequence.

6. The method of claim 1 wherein the basis functions are the extracted feature vectors.

7. The method of claim 1 wherein the basis functions are defined responsive to the extracted feature vectors.

8. The method of claim 1 wherein the feature vector for a video frame includes coefficients determined by applying a set of filters to the video frame.

9. The method of claim 8 wherein the set of filters are wavelet filters, Gabor filters, DCT filters or Fourier filters.

10. The method of claim 1 wherein the feature vector for a video frame includes a color histogram, a set of color statistics, an edge histogram, a GIST feature or a SIFT feature.

11. The method of claim 1 wherein the sparse combination for a particular video frame is defined by a set of weighting coefficients for the basis functions, and wherein the set of key frames are selected by:
forming a coefficient matrix, wherein each row of the coefficient matrix is comprised of the weighting coefficients for a different video frame in the set of video frames;
using a clustering algorithm to analyze the coefficient matrix to define at least one cluster of similar video frames; and
selecting at least one representative video frame from each cluster of similar video frames to be the key video frames.

12. The method of claim 11 wherein the video frame that is closest to the centroid of each cluster of similar video frames is selected as a key video frame.

13. The method of claim 11 wherein an image quality metric is determined for each video frame in a cluster of similar video frames, and wherein the video frame having the highest image quality metric is selected as a key video frame.

14. The method of claim 1 wherein the sparse combination for a particular video frame is defined by a set of weighting coefficients for the basis functions, and wherein the set of key frames are selected by:
forming a coefficient matrix, wherein each row of the coefficient matrix is comprised of the weighting coefficients for a different video frame in the set of video frames;
using a link analysis algorithm to analyze the coefficient matrix to determine ranking scores for each video frames providing an indication of the relative importance of the video frames; and
selecting one or more video frames to be the key video frames responsive to the ranking scores.

15. The method of claim 14 wherein the video frames with the highest ranking scores are selected to be the key video frames.

16. The method of claim 14 wherein the process of selecting the key video frames includes:
forming a ranking function expressing the ranking score as a function of a video frame number;
selecting one or more video frames corresponding to local extrema of the ranking function to be the key video frames.

17. The method of claim 1 further including using the key video frames to index the video sequence, to create video thumbnails, to create a video summary, to extract still image files, to make a photo collage or to make prints.
